(19) United States
(12) Patent Application Publication
(10) Pub. No.: US 2009/0032171 A1
(43) Pub. Date: Feb. 5, 2009

(54) FANFOLD THERMAL INSULATION AND METHOD OF MANUFACTURE

(75) Inventors: Ralph R. Callear, Morley, MI (US); Curtis L. Vandyke, Grand Haven, MI (US); Catherine L. Taylor, Caledonia, MI (US); Sean M. Fey, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: R.L. ADAMS PLASTICS, INC., Wyoming, MI (US)

(21) Appl. No.: 12/126,054

(22) Filed: May 23, 2008

Related U.S. Application Data
(60) Provisional application No. 60/963,133, filed on Aug. 2, 2007.

(51) Int. Cl. E04C 2/30; B32B 7/08

(52) U.S. Cl. 156/92; 52/509

(57) ABSTRACT

Fanfold thermal insulation and method of manufacture includes an elongated generally planar web comprising a plurality of generally planar sheets of non-fibrous thermal insulation material. A plurality of connectors are positioned at an interface between adjacent edge portions of two of the sheets. The connectors hold the two sheets together in a particular rotational relationship that allows rotation of the sheets about an axis generally coincident the adjacent edge portions of the sheets. The particular rotational relationship allows rotation between a first orientation in which the sheets are in facial contact and a second orientation in which the sheets are generally aligned in a plane. The connectors comprise at least two hinges defined by a continuous portion of the thermal insulation material spanning the sheets and a disconnected extent of the adjacent edge portions that is between the hinges. The adjacent edge portions are substantially disconnected at the disconnected extent.

### CROSS REFERENCE TO RELATED APPLICATIONS

The present application claims priority from U.S. provisional patent application Ser. No. 60/963,133, entitled FANFOLD THERMAL INSULATION AND METHOD OF MANUFACTURE, filed Aug. 2, 2007 the disclosure of which is hereby incorporated herein by reference in its entirety.

### BACKGROUND OF THE INVENTION

The present invention is directed to a thermal insulation product and a method of manufacture that folds in a fanfold for transportation and lays flat when unfolded and, in particular, to a thermal insulation product made from a non-fibrous thermal insulation material.

Thin thermal insulation webs, or sheets, have many uses. For example, they are used on the exterior of structures in order to prepare the structure for siding. They may additionally be used to insulate foundations below grade, provide roofing substructure, or the like. The insulation web is capable of covering over undulations in the undersurface as well as providing some thermal insulation to the wall of the structure. Such thermal insulation may be supplied in relatively long webs that are formed in such a manner that the web may be folded in a fan, or accordion, configuration as a bundle in order to allow the web to be easily transported and stored.

### SUMMARY OF THE INVENTION

A fanfold insulation and method of manufacture according to the embodiments in the invention disclosed herein are capable of overcoming many of the difficulties of known fanfold insulation product. A fanfold insulation product and method according to the present invention can be provided in a manner that the web is able to lay flat against the wall when the web is unfolded. In addition, it has sufficient strength in the connections between adjacent sheets of the thermal insulation material to resist tearing of the connector between adjacent sheets. In addition, a fanfold insulation product and method of manufacture according to embodiments of the invention is capable of meeting these quality needs at a relatively low material cost. Because insulation material, itself, is typically manufactured from petroleum-based products or other source of polymeric material, it is important that the material be capable of providing thermal insulation capabilities in a manner that makes efficient use of material that goes into the insulation product.

A fanfold thermal insulation product and method of manufacture, according to an aspect of the invention, includes providing an elongated generally planar web comprising a plurality of generally planar sheets of non-fibrous thermal insulation material, and the sheets define opposite surfaces. A plurality of connectors are provided, each connector being positioned at an interface between adjacent edge portions of two of the sheets. The connectors hold the two sheets together in a particular rotational relationship that allows rotation of two of the sheets about an axis generally coincident the adjacent edge portions of two of the sheets. The particular rotational relationship allows rotation between a first orientation in which two of the sheets are in facial contact and a second orientation in which two of the sheets are generally aligned in a plane. The connectors comprise at least two hinges defined by a continuous portion of the non-fibrous thermal insulation material spanning two of the sheets and a disconnected extent of the adjacent edge portions that is between the at least two hinges. The adjacent edge portions are substantially disconnected at the disconnected extent.

The disconnected extent may comprise a majority of a length of the adjacent edge portions. Two of the hinges may be at opposite ends of the adjacent edge portions. A third hinge may be provided between the two hinges. Additionally, a fourth hinge may be provided between the two hinges. The continuous portion of the thermal insulation material may be crimped to define the two or more hinges. The continuous portion of the thermal insulation material may be crimped from the direction of one of the opposite surfaces, thereby defining the particular rotational relationship.

The thermal insulation assembly may include at least one membrane adding strength to the thermal insulation assembly. The membrane may be adhered to at least one of the opposite surfaces. The plurality of connectors may be arranged along the insulation assembly with the particular rotational relationship alternating between adjacent interfaces. The non-fibrous material may comprise foam insulation material.

A fanfold thermal insulation product and method of manufacture, according to another aspect of the invention, includes providing an elongated generally planar web comprising a plurality of generally planar sheets of non-fibrous thermal insulation material, and the sheets define opposite surfaces. A plurality of connectors are provided, each connector being positioned at an interface between adjacent edge portions of two of the sheets. The connectors hold the two sheets together in a particular rotational relationship that allows rotation of two of the sheets about an axis generally coincident the adjacent edge portions of two of the sheets. The particular rotational relationship allows rotation between a first orientation in which two of the sheets are in facial contact and a second orientation in which two of the sheets are generally aligned in a plane. The connectors comprise at least two hinges defined by a continuous portion of the non-fibrous thermal insulation material spanning two of the sheets and a disconnected extent of the adjacent edge portions that is between the at least two hinges. The adjacent edge portions are substantially disconnected at the disconnected extent. An anti-tear interface may be provided between the disconnected extent and one of the hinges. The anti-tear interface resists elongation of the disconnected extent.

The anti-tear interface may be a feature that is punched in the continuous portion adjacent to the disconnected extent. The feature may be a punched portion that is generally perpendicular to the disconnected extent. The punched portion may be generally cylindrical.

These and other objects, advantages and features of this invention will become apparent upon review of the following specification in conjunction with the drawings.

### BRIEF DESCRIPTION OF THE DRAWINGS

FIG. 1 is a perspective view of a fanfold thermal insulation product according to an embodiment of the invention;

FIG. 2 is an enlarged perspective view of the area designated II in FIG. 1;

FIG. 3 is a perspective view of a fanfold thermal insulation product according to an alternative embodiment of the invention;

FIG. 4 is an enlarged perspective view of the area designated IV in FIG. 3;

FIG. 5 is a side elevation of a method of manufacturing a fanfold thermal insulation product according to an embodiment of the invention;

FIG. 6 is an end elevation of the method illustrated in FIG. 5;

FIG. 7 is an enlarged side elevation of the area indicated VII-VII in FIG. 6;

FIG. 8 is an enlarged side elevation of the area indicated VIII-VIII in FIG. 6;

FIG. 9 is an enlarged side elevation of the area indicated IX-IX in FIG. 6;

FIG. 10 is an end elevation of a crimp bar;

FIG. 11 is an end elevation of a combination punch and backup bar;

FIG. 12 is a top plan view of the bar in FIG. 11; and

FIG. 13 is a perspective view of a fanfold thermal insulation product according to an alternative embodiment of the invention.

### DESCRIPTION OF THE PREFERRED EMBODIMENT

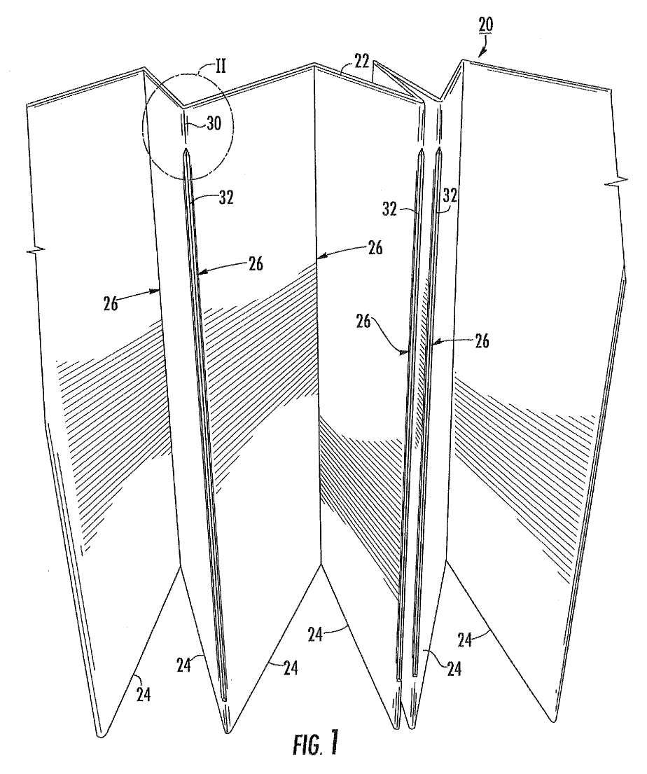

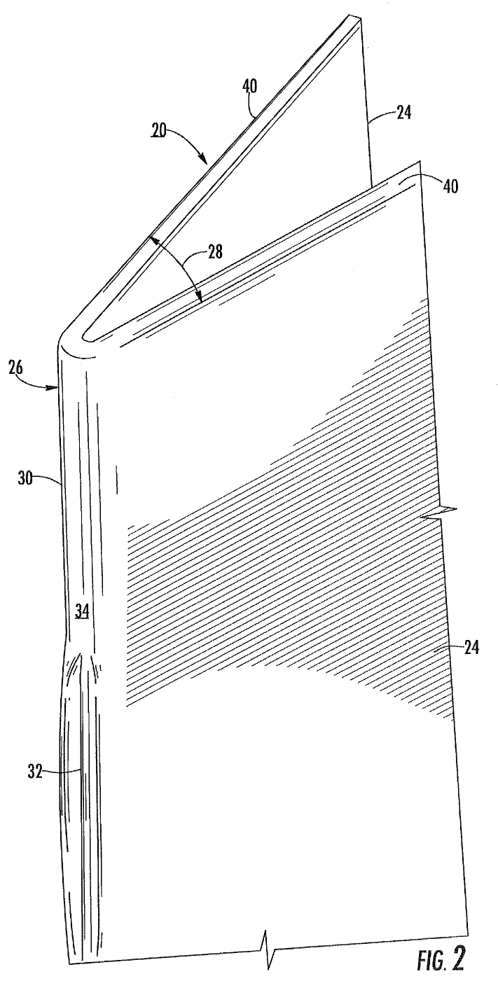

Referring now specifically to the drawings, and the illustrative embodiments depicted therein, a fanfold thermal insulation product 20 is made from a generally elongated planar web of non-fibrous thermal insulation material 22 that is divided into a plurality of generally planar sheets of thermal insulation material 24 that are interconnected by connectors 26 (FIGS. 1 and 2).

Each connector 26 holds two of adjacent sheets 24 together in a particular rotational relationship 28 that allows rotation of the sheets about an axis generally coincident with adjacent edge portions of the two sheets. The particular rotational relationship allows rotation between a first orientation in which two of the sheets are in facial contact and a second orientation in which the sheets are generally aligned in a plane. Thus, when the sheets are in are in the first orientation, in facial contact, the fanfold thermal insulation product is in a compact bundle for transportation and storage. When connector 26 is in the second or generally planar orientation, the sheets are all aligned in a plane thereby allowing the thermal insulation product to be used, such as applied to a surface such as an exterior wall, or the like. As can best be seen in FIG. 1, the connectors are arranged with the particular rotational relationships alternating between alternating connectors, thereby allowing the fanfold thermal insulation product to fold in a fanfold manner.

Each connector 26 is made up of two or more hinges 30 and at least one disconnected extent 32 extending in areas not occupied by a hinge 30. Each hinge 30 is formed at a continuous portion 34 of the thermal insulation material that spans the two adjacent sheets 24. Each disconnected extent 32 is an area where the thermal insulation material is at least partially severed between the sheets of thermal insulation material. Hinge 30 may be formed by crimping the continuous portion 34 of the thermal insulation material. In the illustrative embodiment, the crimp is made from the direction of the interior of the adjacent planar sheets in the folded position, as will be explained in more detail below. Alternatively, the crimp could be made from the direction of the exterior of the adjacent planar sheets or from both the direction of the interior and the direction of the exterior of the adjacent planar sheets.

Because of the construction of connector 26, the planar web is capable of laying generally flat when in use without substantial humps in the web. It is believed that the unique combination of the connectors and the disconnected extent of the material between the connectors allows the planar web to lay flat. Moreover, forming the hinge of a continuous portion of the thermal insulation material that is crimped resists the tendency for the connector to tear. In the embodiment illustrated in FIGS. 1 and 2, hinges 30 are positioned only at opposite ends of connector 26 with disconnect extent extending right up to the hinges. In order to provide additional strength to the web of thermal insulation material, a membrane 40 may be applied to the web of thermal insulation material. The membrane may be applied to one or both outer surfaces of the web. Membrane 40 will be severed when on the surface of the connector that is exterior the adjacent folded sheets and is folded upon itself when on the surface of the connector that is interior of the folded sheets. Either way, the membrane does not significantly interfere with folding of the sheets. Alternatively, membrane 40 may be formed within the planar web with thermal insulation material on both sides of the membrane.

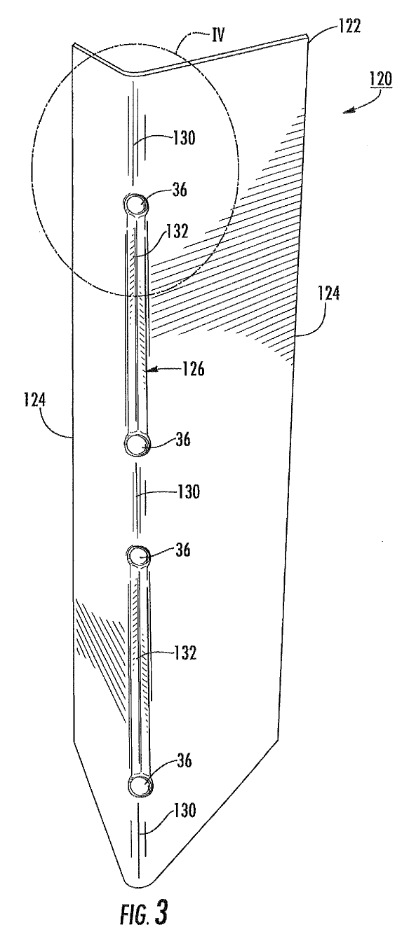

In an alternative embodiment, a fanfold thermal insulation product 120 is made from a generally planar web of thermal insulation material 122 that is divided into a plurality of generally planar sheets of thermal insulation material 124 and connected with three or more hinges 130, one at each end of the connector 126 and one in the middle. Disconnected extents 132 are provided between the hinges (FIGS. 3 and 4). Thus, for fanfold thermal insulation product 120, there are two disconnected extents 132. Because of the additional strength provided by the third hinge, fanfold thermal insulation product 120 does not have a membrane. This allows the cost of the product to be further reduced because the membrane does not provide substantial thermal insulation properties but adds to the material cost of the product. Its use in fanfold thermal insulation is as a strengthening agent in order to provide mechanical integrity to the product. Because of the use of more than two hinges, fanfold insulation product 120 is sufficiently strong without the use of a membrane. However, a membrane could be used with a product having more than two hinges.

Fanfold thermal insulation assembly 120 may additionally include an anti-tear interface 36 between each hinge and the associated disconnect extent 132. The anti-tear interface resists elongation of the disconnected extent, thereby preserving the strength of the web by preventing the disconnected extent from expanding or elongating into the hinge. In the illustrative embodiment, the anti-tear interface is made by a punched portion 38 of the continuous portion 134 of the insulation material between adjacent planar sheets. In the illustrative embodiment, the punched portion is in a generally circular or cylindrical pattern. However, other patterns may be used in order to resist elongation of the disconnected extent of the thermal insulation material. Also, other techniques may be used to provide an anti-tear interface. Such additional techniques may be made by modifying the configuration of the disconnected extent at its ends, such as by providing a circular cutout of the thermal insulation material at the ends of the disconnected extent. Other techniques may be apparent to the skilled artisan, such as by applying heat or a chemical agent to deform or otherwise modify the interface between the hinge and the disconnected extent.

In yet another alternative embodiment, a fanfold insulation product 220 is made from a generally planar web of thermal insulation material 222 that is divided into a plurality of generally planar sheets of thermal insulation material 224 and connected with four hinges 230, one located at each end of the connector and two located between the ends (FIG. 13). Thus, for fanfold insulation product 220, there are three disconnected extents 232. Insulation product 220 is stronger than insulation product 120 while incurring little if any additional cost. These gains in strength will carry benefits and advantages similar to those discussed in connection with insulation product 120, discussed above.

In the illustrative embodiment, fanfold thermal insulation product 20, 120, 220 is manufactured from a non-fibrous thermal insulation material of the type that is known in the art. This may include, by way of example, a polystyrene foam having a foam density, by way of example, from 2.2 to 2.9 pounds per cubic foot. However, other densities such as greater than 2.9 pounds or less than 2.2 pounds per cubic foot may be used. Also, other types of foams or non-fibrous materials may be used. In the illustrative embodiment, membrane 40 may be a polymeric material, such as polystyrene or polypropylene film, or the like, of the type that is known in the art. The thermal insulation foam web or sheet may be made by extrusion. The result is a thermal product having a nominal R value on an order of magnitude of 1, although a wide range of R values can be made utilizing the disclosed embodiments.

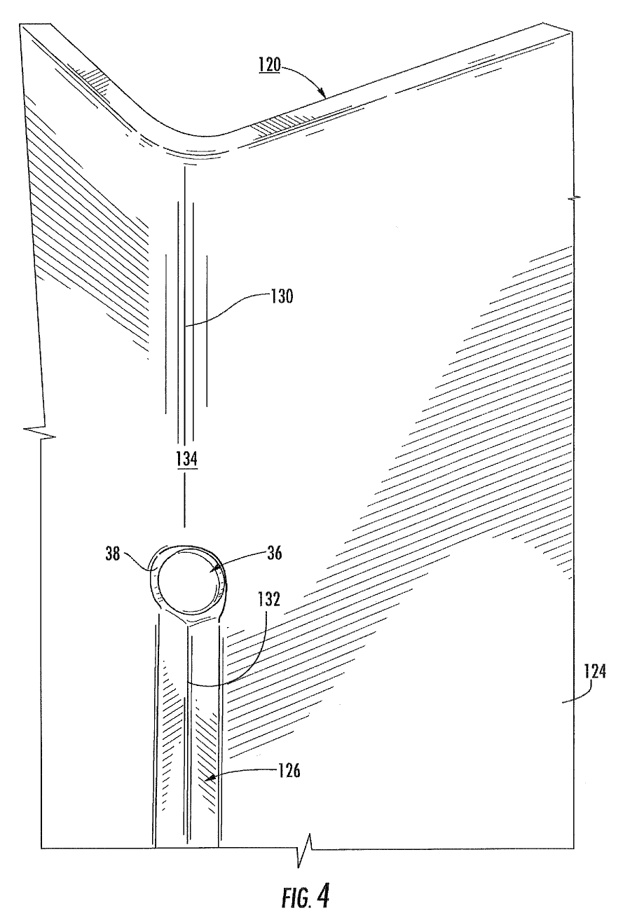

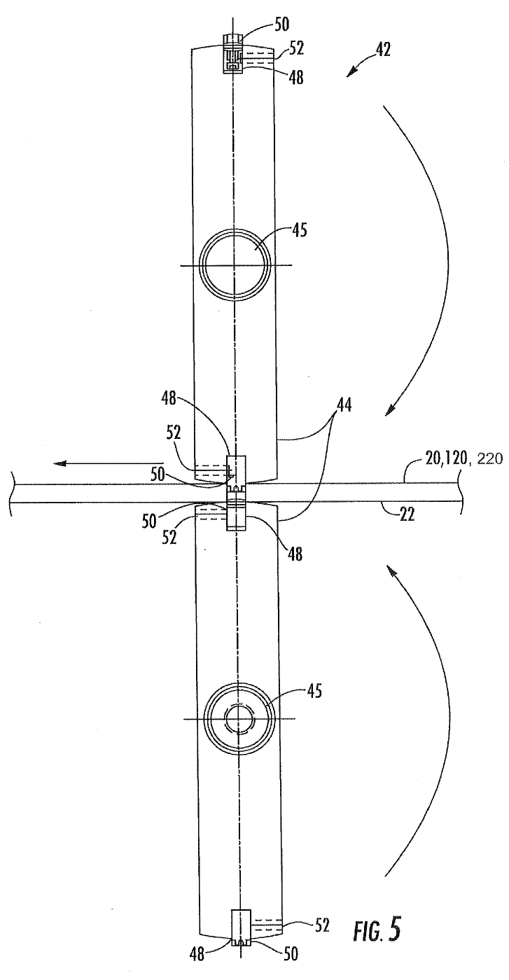

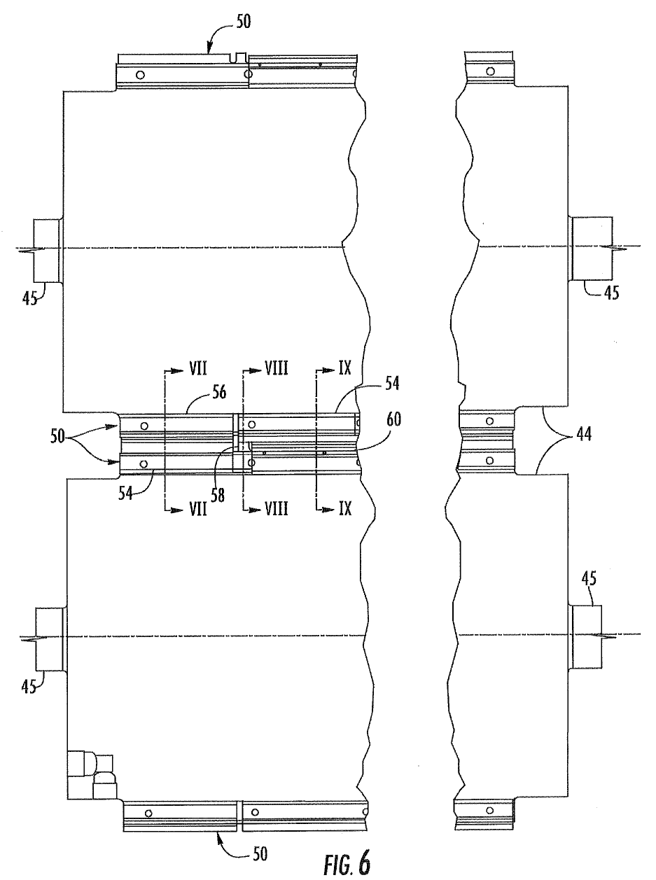

A method 42 of manufacturing fanfold thermal insulation product includes passing generally planar web 22 between a pair of synchronized rotors 44 which rotate about parallel shafts 45 (FIGS. 5-12). Rotors 44 have a length that coincides with the width of the web and includes edge portions 46 having milled slots 48 therein. Milled slots 48 retain tooling members 50, such as by the use of setscrews 52 extending along the length of the slot. In this manner, the planar web is divided into sheets 24 of thermal insulation material by the production of a connector 26 for every 180 degree rotation of the rotors 44. As will be explained in more detail below, the tooling 50 is arranged in slots 48 in a manner that the particular orientation 28 alternates between adjacent connectors 26. Rotors 44 may be heated or cooled, if desired, to assist the process.

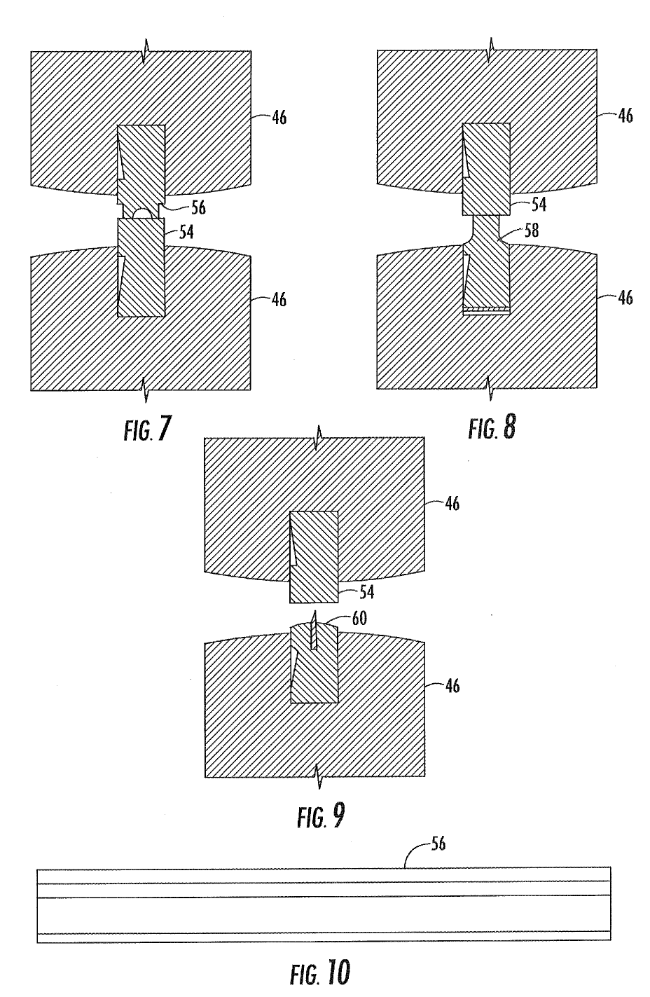

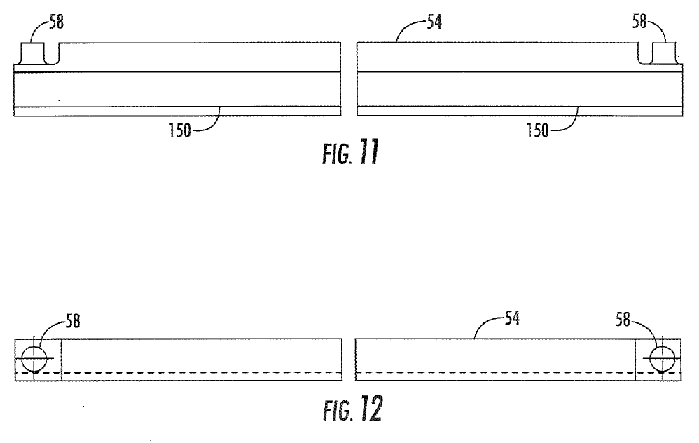

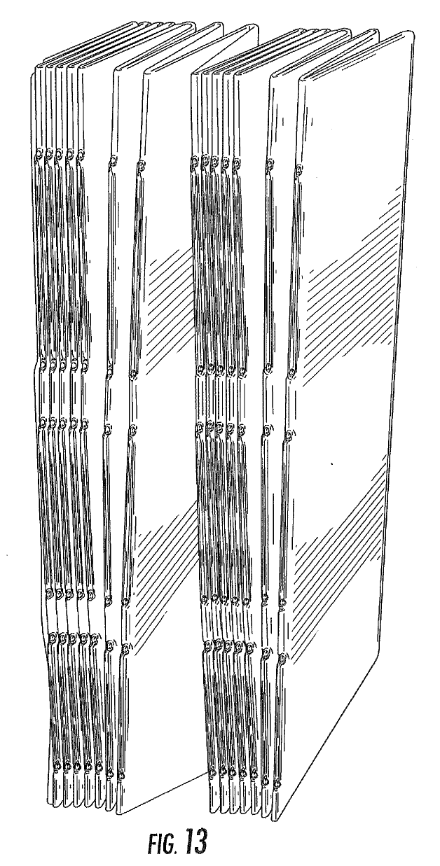

Tooling 50 includes a crimp tool 56, which is used in combination with a backup bar 54, to form hinge 30 (FIGS. 6 and 7). Alternatively, two crimp tools may be used in combination to crimp from opposite directions, such as, for example, from the bottom and the top of the planar web. While crimp tool 56 and backup bar 54 are illustrated as having a substantially zero clearance, a positive clearance could be utilized. Tooling 50 may additionally include a punch tool 58 used in combination with a backup bar 54. Punch tool 58, when used, produces punch portion 38 adjacent to the disconnected extent 32. As best seen by comparing FIGS. 11 and 12, punch 58 includes a cylindrical wall that is hollow in the middle. This results in punch portion 38 having a cylindrical recess around a raised center portion of the foam. Tooling 50 may additionally include an elongated knife 60 used in combination with a backup bar 54 (FIGS. 6 and 9). Knife 60 is for the purpose of producing disconnecting extent 32. Knife 60 may be a serrated blade that is oriented with respect to the corresponding backup bar 54 with a positive clearance, so that the disconnected extent does not initially extend completely through the thickness of planar web 22. This maintains the integrity of web 22 as it is moving through the manufacturing method 42. As the fanfold thermal insulation product exits the manufacturing method, the folding of the web into the fanfold configuration causes the disconnected extent 32 to completely or substantially sever so that disconnected extent 32 extends through the thickness of the planar web 22. However, a zero clearance could be used.

In the illustrative embodiment, crimp tool 56 approaches web 22 from one side thereof and punch tool 58 and knife 60 approaches the web from the opposite side thereof. Crimp tool 56 approaches the web from the direction upon which the planar sheets 24 are folded upon each other. The tooling 50 is arranged on synchronized rotors 44 such that the crimp tool, punch tool and knife all approach the web from different directions for every 180 degree rotation of the rotors. This provides the alternating of the rotational relationship for alternating interfaces between planar sheets 24 that enables the fanfold configuration.

In an alternative embodiment, a tooling member 150 includes a combination of a punch tool 58 for forming punch portion 38 and a backup bar 54 which operates in unison with the crimp tool 56 which approaches the web from the opposite direction (FIG. 11). The combination of these two functions in a single tooling member reduces the setup effort for the method of manufacture. Rotors 44 may be moved in synchronism using conventional techniques, such as servomotors, mechanical couplings, or the like.

Changes and modifications in the specifically described embodiments can be carried out without departing from the principles of the invention which is intended to be limited only by the scope of the appended claims, as interpreted according to the principles of patent law including the doctrine of equivalents.

1. A fanfold thermal insulation assembly, comprising:
an elongated generally planar web comprising a plurality of generally planar sheets of non-fibrous thermal insulation material, said sheets each defining opposite surfaces;
a plurality of connectors, each connector positioned at an interface between adjacent edge portions of two of said sheets, each said connector holding said two of said sheets together in a particular rotational relationship allowing rotation of said two of said sheets about an axis generally coincident said adjacent edge portions of said two of said sheets, said particular rotational relationship allowing rotation between a first orientation in which said two of said sheets are in facial contact and a second orientation in which said two of said sheets are generally aligned in a plane; and
said connectors comprising at least two hinges defined by a continuous portion of said non-fibrous thermal insulation material spanning said two of said sheets, and a disconnected extent of said adjacent edge portions that is between said at least two hinges, wherein said adjacent edge portions are substantially disconnected at said disconnected extent.

2. The thermal insulation assembly as claimed in claim 1 wherein said disconnected extent comprises a majority of a length of said adjacent edge portions.

3. The thermal insulation assembly as claimed in claim 1 wherein said at least two hinges are at opposite ends of said adjacent edge portions.

4. The thermal insulation assembly as claimed in claim 1 wherein said connectors further comprise at least a third hinge between said at least two hinges.

5. The thermal insulation assembly as claimed in claim 4 wherein said connectors further comprise at least a fourth hinge between said at least two hinges.

6. The thermal insulation assembly as claimed in claim 1 wherein said continuous portion of said thermal insulation material is crimped to define said at least two hinges.

7. The thermal insulation assembly as claimed in claim 6 wherein said continuous portion of said thermal material is crimped from the direction of one of said opposite surfaces thereby defining said particular rotational relationship.

8. The thermal insulation assembly as claimed in claim 1 including at least one membrane adding strength to said thermal insulation assembly.

9. The thermal insulation assembly as claimed in claim 8 wherein said at least one membrane is adhered to at least one of said opposite surfaces.

10. The thermal insulation assembly as claimed in claim 1 wherein said plurality of connectors being arranged along said insulation assembly with said particular rotational relationship alternating between adjacent interfaces.

11. The thermal insulation assembly as claimed in claim 1 wherein said non-fibrous insulation material comprises a foam insulation material.

12. A fanfold thermal insulation assembly, comprising:
an elongated generally planar web comprising a plurality of generally planar sheets of non-fibrous thermal insulation material, said sheets each defining opposite surfaces;
a plurality of connectors, each connector positioned at an interface between adjacent edge portions of two of said sheets, each said connector holding said two of said sheets together in a particular rotational relationship allowing rotation of said two of said sheets about an axis generally coincident said adjacent edge portions of said two of said sheets, said particular rotational relationship allowing rotation between a first orientation in which said two of said sheets are in facial contact and a second orientation in which said two of said sheets are generally aligned in a plane; and
said connectors comprising at least two hinges defined by a continuous portion of said non-fibrous thermal insulation material spanning said two of said sheets, and a disconnected extent of said adjacent edge portions that is between said at least two hinges, wherein said adjacent edge portions are substantially disconnected at said disconnected extent; and
an anti-tear interface between said disconnected extent and one of said hinges, said anti-tear interface resisting elongation of said disconnected extent.

13. The thermal insulation assembly as claimed in claim 12 wherein said anti-tear interface comprises a feature punched in said continuous portion adjacent to said disconnected extent.

14. The thermal insulation assembly as claimed in claim 13 wherein said feature comprises a punched portion that is generally perpendicular to said disconnected extent.

15. The thermal insulation assembly as claimed in claim 14 wherein said punched portion is generally cylindrical.

16. A method of manufacturing a fanfold thermal insulation assembly, said method comprising:
providing an elongated generally planar web comprising a plurality of generally planar sheets of non-fibrous thermal insulation material, said sheets each defining opposite surfaces;
forming a plurality of connectors positioned at an interface between adjacent edge portions of two of said sheets and spaced along said web at spaced apart locations thereby defining said plurality of generally planar sheets, each said connector holding said two of said sheets together in a particular rotational relationship allowing rotation of said two of said sheets about an axis generally coincident with adjacent edge portions of said two of said sheets, said particular rotational relationship allowing rotation between a first orientation in which said two of said sheets are in facial contact and a second orientation in which said two of said sheets are generally aligned in a plane; and
said forming comprising forming at least two hinges at a continuous portion of said planar web spanning said two of said sheets and a disconnected extent of said web being between said at least two hinges, said disconnected extent being where said two of said sheets are substantially disconnected.

17. The method of claim 16 wherein said disconnected extent comprises a majority of a length of said interface.

18. The method as claimed in claim 16 wherein said forming at least two hinges comprises forming said at least two hinges at opposite ends of said interface.

19. The method as claimed in claim 16 wherein said connectors further comprise at least a third hinge between said at least two hinges.

20. The method as claimed in claim 19 wherein said connectors further comprise at least a fourth hinge between said at least two hinges.

21. The method as claimed in claim 16 including crimping said continuous portion of said thermal insulation material to define said at least two hinges.

22. The method as claimed in claim 21 including crimping said continuous portion of said thermal insulation material from the direction of one of said opposite surfaces thereby defining said particular rotational relationship.

23. The method as claimed in claim 16 including applying at least one membrane adding strength to said thermal insulation assembly.

24. The method as claimed in claim 23 including adhering said at least one membrane to at least one of said opposite surfaces.

25. The method as claimed in claim 16 wherein said forming further comprises forming said connectors with said particular rotational relationship alternating between alternating said connectors.

26. The method as claimed in claim 16 wherein said non-fibrous thermal insulation material comprises a foam insulation material.

27. A method of manufacturing a fanfold thermal insulation assembly, said method comprising:
providing an elongated generally planar web comprising a plurality of generally planar sheets of non-fibrous thermal insulation material;
forming a plurality of connectors spaced along said web at spaced apart locations thereby defining said plurality of generally planar sheets, each said connector holding two of said sheets together in a particular rotational relationship allowing rotation of said two of said sheets about an axis generally coincident with adjacent edge portions of said two of said sheets, said particular rotational relationship allowing rotation between a first orientation in which said two of said sheets are in facial contact and a second orientation in which said two of said sheets are generally aligned in a plane; and
said forming comprising forming at least two hinges at a continuous portion of said planar web spanning said two of said sheets and a disconnected extent of said web being between said at least two hinges, said disconnected extent being where said two of said sheets are substantially disconnected; and
forming an anti-tear interface between said disconnected extent and one of said hinges, said anti-tear interface resisting elongation of said disconnected extent.

28. The method as claimed in claim 27 wherein said forming said anti-tear interface comprises punching a feature in said continuous portion adjacent to said disconnected extent.

29. The method as claimed in claim 28 wherein said feature is generally perpendicular to said disconnected extent.

30. The method as claimed in claim 29 wherein said feature is generally cylindrical.
